(19) United States
(12) Patent Application Publication
(10) Pub. No.: US 2008/0140642 A1
(43) Pub. Date: Jun. 12, 2008

(54) AUTOMATED USER ACTIVITY ASSOCIATED DATA COLLECTION AND REPORTING FOR CONTENT/METADATA SELECTION AND PROPAGATION SERVICE

(76) Inventors: Bill Messing, Seattle, WA (US); Michael Hyman, Bellevue, WA (US); Jan S. Drake, Seattle, WA (US); Nils B. Lahr, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/870,401

(22) Filed: Oct. 10, 2007

Related U.S. Application Data
(60) Provisional application No. 60/850,841, filed on Oct. 10, 2006.

(51) Int. Cl. G06F 17/30

(52) U.S. Cl. 707/5; 707/E17.143

(57) ABSTRACT

In various embodiments, a client device is endowed with a client data collection and management service, a client content/metadata selection and propagation service and a client content presentation, to automatically collect user activity associated data to support a content/metadata selection and propagation service to select and propagate content/metadata more efficiently, flexibly and effectively (with high relevancy).

### RELATED APPLICATIONS

The present non-provisional application claims priority to provisional application No. 60/850,841, entitled Automatic Activity Based Construction of a Persona Representation, filed on Oct. 10, 2006, and to provisional application No. 60/854,802, entitled ‘Display of Contextual Advertising as a Form of User Generated Content”, filed Oct. 27, 2006.

### TECHNICAL FIELD

The present invention relates generally to the fields of data processing and information technology. More specifically, embodiments of the present invention relate to automated user activities associated data collection on a client device for a content and metadata selection propagation service to select and propagate content and/or metadata, which applications include e.g. intelligent automation of content publishing activities related to publishing and propagating of personal content on the World Wide Web (WWW) and other computer networks.

### BACKGROUND

With advances in computing, networking and related technologies, more and more computing devices are networked together, with more and more content available to the networked computing users. For example, billions of content pages/objects are available on the WWW for Internet users. However, publication and propagation of contents in a relevant manner, that is publishing and propagating content to those would be interested, remain a challenge.

For example, social networks on the Internet have become very popular in recent years. Social networks typically consist of two main elements: 1) users; and 2) the content within the network, such as home pages and images, that the users come to the network to view. For a network to become successful, it must attract users who will both produce and consume content. In the social networks that exist today, content is typically produced (i.e. published) by users using a traditional publishing approach. That is, when a user has something he or she decides to share, the user uses the social network system to create (publish) the content—for example by writing a blog entry, by uploading an image, or by rearranging his or her home page. This set of explicit actions lets a user construct a representation, available for others to view, of his or her personality and interests, or persona. This approach allows for the display of a breadth of content, but it requires users to actively update their content in order to maintain the interest of viewers. Because updating content is labor-intensive for the publisher, sites typically have a very large difference between the number of people viewing and the number of people creating content, sometimes as much as 100:1. This means that the social network system must attract a very large number of people in order to have enough actively changing content to generate repeat traffic. Typically such social network systems have a large number of publishers who create an initial page and then rarely or never update it. Likewise, the abandonment rate of viewers is also often high. Viewers must be dedicated in order to find new and interesting content. Thus, increased automation in content publication and propagation in a relevant manner would be desirable.

Such increased in automation is likely to require increase knowledge of the users and/or contents. Collecting data on a client computer is not new. Prior art programs have log user interactions for many reasons, for example, to enable debugging based on user triggered events or to enable an audit trail. Traditionally it is known prior to the distributions of a program what will be monitored and as such what is being logged is built into a specific program. The problem with these methods is that wanting to log something new requires a new program to be distributed. Additionally, programs typically monitor only their own events and perhaps a few global operating system status variables, such as memory utilization, CPU utilization and available disk space. Today's methods for data collection are useful but do not enable a more fluid system to exist which can change over time, allowing the activities that are logged to be increased or decreased easily. Further, the systems that do collect data on overall client activities typically generate a large amount of data which is in turn not optimized for utilization in real time.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates selected components of a client device and user activity associated data collection operations performed thereon in further details, in accordance with various embodiments of the present invention;

FIG. 3 illustrates selected components of a client device and relevant content publication and propagation related operations, in accordance with various embodiments of the present invention;

FIG. 4 illustrates an example computer system suitable for use as a client device to practice various embodiments of the present invention; and

FIGS. 5-6 illustrate application to the publication of persona representation in a social network, in accordance with various embodiments of the present invention.

### DETAILED DESCRIPTION OF ILLUSTRATIVE EMBODIMENTS

Illustrative embodiments of the present invention include, but are not limited to, methods and apparatuses for automated collection of user activities associated data on a client device for content/metadata selection and propagation service. The methods and apparatuses having particular application to automated construction of a persona representation in a social network.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

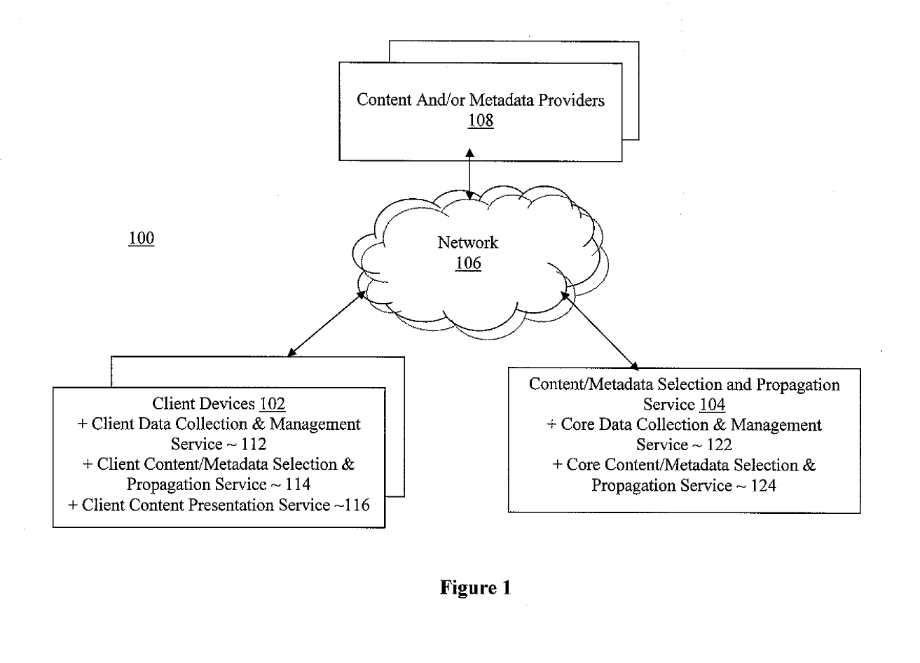

FIG. 1 illustrated as overview of the present invention, in accordance with various embodiments. Illustrated therein are a number of client devices 102, a content/metadata selection and propagation service 104, and a number of content/metadata providers 108 coupled to each other via network 106. Client Devices 102 are endowed with the teachings of the present invention to support content/metadata selection and propagation service 104, to enable automated content/metadata publication and propagation in a more efficient and relevant manner. More specifically, client devices 102 are endowed with teachings that enable user activity associated data to be automated collected and reported (optionally, filtered and/or modified prior to reporting) and content/metadata to be presented on the respective client devices, with the data collection, processing and reporting, and content/metadata presentation being performed more efficiently, flexibly and effectively.

For the illustrated embodiments, each client device 102 may be endowed with at least a client data collection and management service 112, a client content/metadata selection and propagation service 114 and a client content presentation service 116. At least one embodiment each of services 112 and 114 is described in further detail. In various embodiments, client content presentation service 116 is preferably configured to be able selective present messages of a wide range of media. In various embodiments, content/metadata selection and propagation service 104 may be endowed with a core data collection and management service 122 and a core content/metadata selection service 124, complementary to services 112 and 114. Various implementations of services 122 and 124 are the subject matters of co-pending application entitled “A Content/Metadata Selection and Propagation Service to Propagate Content/Metadata to Client Devices”, having common inventorship with the subject application, and contemporaneously filed (application number to be assigned). For further details of services 122 and 124, readers are referred to the co-pending application.

Each of client devices 102 may be any one of a broad range of computing or processor based devices known in the art or to be developed, including but not limited to, desktop computers, notebook computers, palm-sized hand-held computing devices, personal digital assistants, smart phones, game consoles, set top boxes, and so forth.

The term “content/metadata” as used herein means content and/or metadata. Content may be commercial or non-commercial in nature, may be public or private, and may be text, graphics, video, audio or multi-media in form. Metadata may be a wide range of data describing technical and/or substantive attributes of the content. Accordingly, each of content/metadata providers may be any one of a wide range of such providers, including but not limited to a commercial or non-commercial website, a video and/or audio service, and so forth.

Content/metadata selection and propagation service 104 may be implemented on a single central computer or a collection of servers, e.g. a cluster of locally networked servers, or a system of distributed servers coupled via one or more local/wide area networks. The various networks may comprise wired or wireless segments/domains.

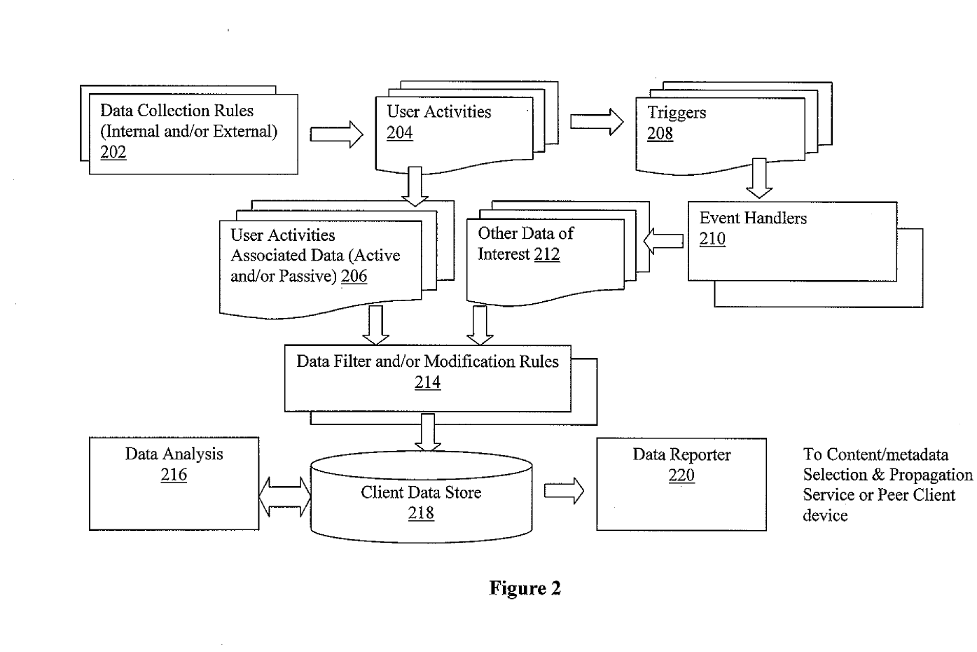

Referring now to FIG. 2, wherein selected components implementing client data collection and management service 112 and their selected operations, in accordance with various embodiments, are illustrated. As shown, for the embodiments, service 112 may comprise a number of data collection rules 202, a number of event handlers 210, a number of data filter and/or data modification rules 214, data analysis modules 216, a local client data store 218, and a data reporter 220, operatively coupled to each other as shown.

Data collection rules 202 may comprise a number of rules to be applied to user activities 204 on the client device to generate a number of user activities associated data 206 and/or a number of trigger events 208. In various embodiments, data collection rules 202 may comprise internal as well as external data collection rules 202. Internal data collection rules 202 are those locally installed on client device to provide local data collection rules typically applicable to only the client device itself, whereas external data collection rules 202 are those provided from an external source (e.g. content/metadata selection and propagation service 104) specifying data collection rules typically apply to a number, a group or a family of client devices. Internal data collection rules 202 may be provided e.g., through a number of portable data medium, such as diskettes, CDROM or flash drives, whereas external data collection rules 204 may be provided e.g. through a network connection coupling the external source to the client device. Accordingly, data collection may be more flexible and may change over time.

For the embodiments, user activities associated data 206 are preferably comprised of actively associated as well as passively associated data. Examples of actively associated data may include e.g. a user clicking or otherwise interacting with a presented content, whereas examples of passively associated data may include e.g. “mouse-over” (but not interacting) with a presented content.

Event handlers 210 are employed to create additional data that may be of interest for various trigger events 208. Each of event handlers 210 may be configured to handle one or more types of trigger events 208. Event handler 210 may e.g. be registered with an operating system service of the operating system environment of a client device to be notified of occurrences of one or more trigger events 208.

Data filter and/or modification rules 214 are configured to filter and/or modify the nominally collected data 206 or other data of interest 212 created by event handlers 210, to streamline the amount of data eventually reported by data reporter 220, enabling more efficient and effective data reporting. Data analysis modules 216 may perform a number of analyses, e.g. statistical analysis or modeling, to analyze, summarize or otherwise model the collected data, enabling data reporter 220 to report the analysis results in lieu of the nominally collected or rolled up data, and selectively including the analyzed data only when necessary, to further streamline data reporting.

As alluded to, data reporter 220 is configured to report the collected or created data, in a filtered or unfiltered, modified or unmodified, analyzed or unanalyzed manner, to content/metadata selection and propagation service 104. In various embodiments, data reporter 220 may also be configured to report the collected or created data, in a filtered or unfiltered, modified or unmodified, analyzed or unanalyzed manner, to a peer client device 102. The peer client device 102 may be a trusted peer client device.

Thus, operationally, as various user activities 204 are observed to take place on client device 102, data collection rules (internal and/or external) 202 are applied to the observed user activities 204 to generate user activities associated data (active or passive) 206 and trigger events 208. In turn, appropriate ones of the events handler 210 are invoked to process applicable ones of the event handlers 210 to create additional data of interest 212. Data Filter and/or modification rules 214 are then applied to data 206 and 212 to filter and/or modify the nominally collected/created user activity associated data. The data, filtered/unfiltered, modified/unmodified may be subjected to various client data analyses. The data collected/created, filter/unfiltered or modified/unmodified, as well as the analysis results may be stored in client data store 218, for reporting by data reporter in batch or in real time.

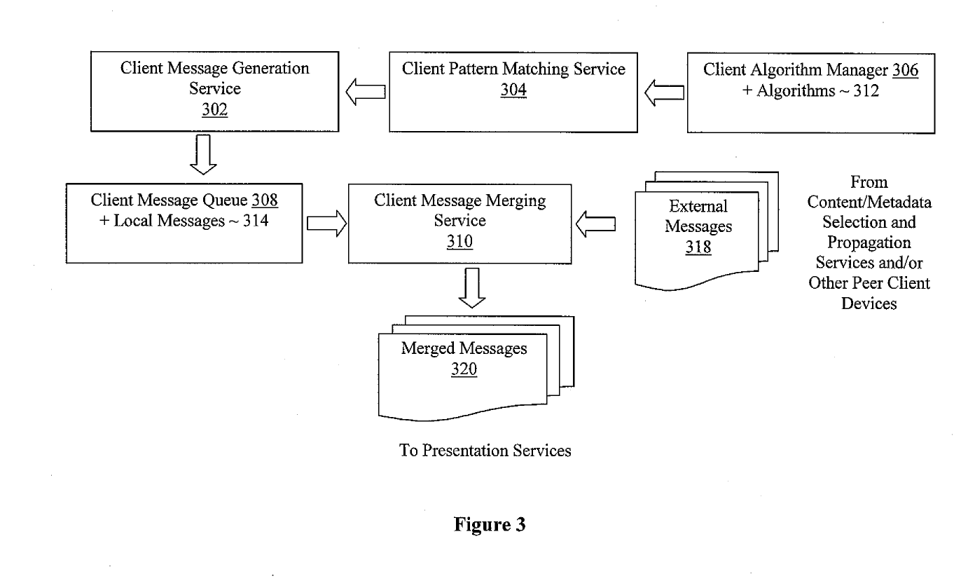

Referring now to FIG. 3, wherein selected components of client content/metadata selection and propagation service 114, and their operations, in accordance with various embodiments, are illustrated. As shown, for the embodiments, content/metadata selection and propagation service 114 may comprise a client message generation service 302, a client pattern matching service 304, various pattern analysis algorithms 312, a client algorithm manager 306, a client message queue 308 and a client message service 310, operatively coupled to each other as shown.

Client pattern matching service 304 is configured to perform local client pattern detection, discerning patterns in user activities on client device, and/or relevancy between content consumed on client device and the user activities. In various embodiments, client pattern matching service 304 performs the client pattern detection/determination, employing a number of locally maintained pattern analysis algorithms 312. Pattern analysis algorithms 312 may be any one of such analysis algorithms known in the art or to be devised. For the embodiments, algorithms 312 are maintained and managed by client algorithm manager 306, which may manage the algorithms to be employed in coordination e.g. with content/metadata selection and propagation service 104, thereby enabling service 104 to influence the patterns discernment, and in turn, content presentation on client device 102.

Content message generation 302 is configured to locally generate messages comprising content and/or metadata 314, and storing them in client message queue 308. Content message merging service 310 is configured to merge external messages 318, e.g. those received from content/metadata selection and propagation service 104 with local message 314 to form merged messages 318 for presentation service 116 to selectively present on client device 104. In various embodiments, external messages 318 provided by content/metadata selection and propagation service 104 may be selected advertisement messages of particular relevance to client device 102. In various embodiments, content message merging service 310 may also be configured to receive and merge external messages 318, e.g. those received from a peer client device 102 with local message 314. In various embodiments, content message merging service 310 may also be configured to send the locally generated messages 314 to other peer client devices 102.

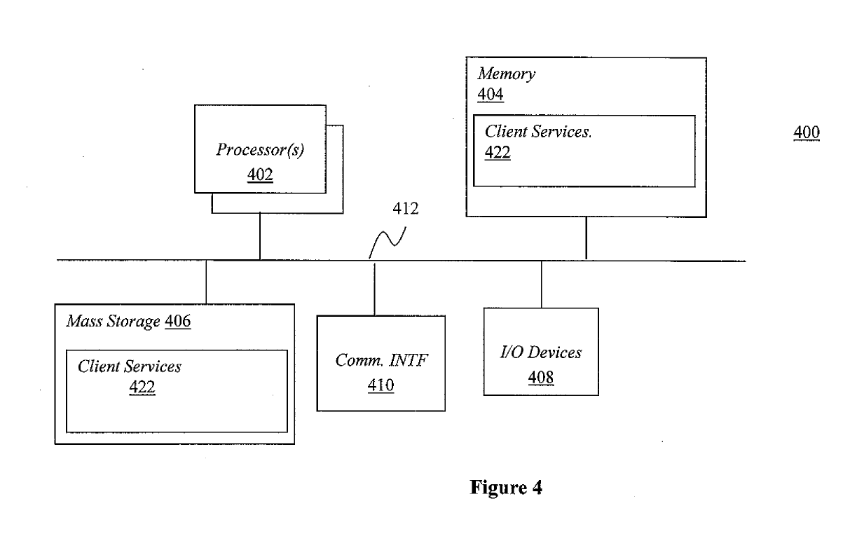

FIG. 4 illustrates an example computer system suitable for use as a client device to practice various embodiments of the present invention. As shown, computing system 400 includes a number of processors or processor cores 402, and system memory 404. For the purpose of this application, including the claims, the terms “processor” and “processor cores” may be considered synonymous, unless the context clearly requires otherwise. Additionally, computing system 400 includes mass storage devices 406 (such as diskette, hard drive, compact disc read only memory (CDROM) and so forth), input/output devices 408 (such as display, keyboard, cursor control and so forth) and communication interfaces 410 (such as network interface cards, modems and so forth). The elements are coupled to each other via system bus 412, which represents one or more buses. In the case of multiple buses, they are bridged by one or more bus bridges (not shown).

Each of these elements performs its conventional functions known in the art. In particular, system memory 404 and mass storage 406 may be employed to store a working copy and a permanent copy of the programming instructions implementing, in whole or in part, services 112 and 114 (client services), including the various components illustrated in FIGS. 2-3, collectively denoted as 422. The various components may be implemented by assembler instructions supported by processor(s) 402 or high-level languages, such as C, that can be compiled into such instructions.

The permanent copy of the programming instructions may be placed into permanent storage 406 in the factory, or in the field, through, for example, a distribution medium (not shown), such as a compact disc (CD), or through communication interface 410 (from a distribution server (not shown)). That is, one or more distribution media having an implementation of the agent program may be employed to distribute the agent and program various computing devices.

The constitution of these elements 402-412 are known, and accordingly will not be further described.

### Application to Creation of Persona Representation in Social Networking

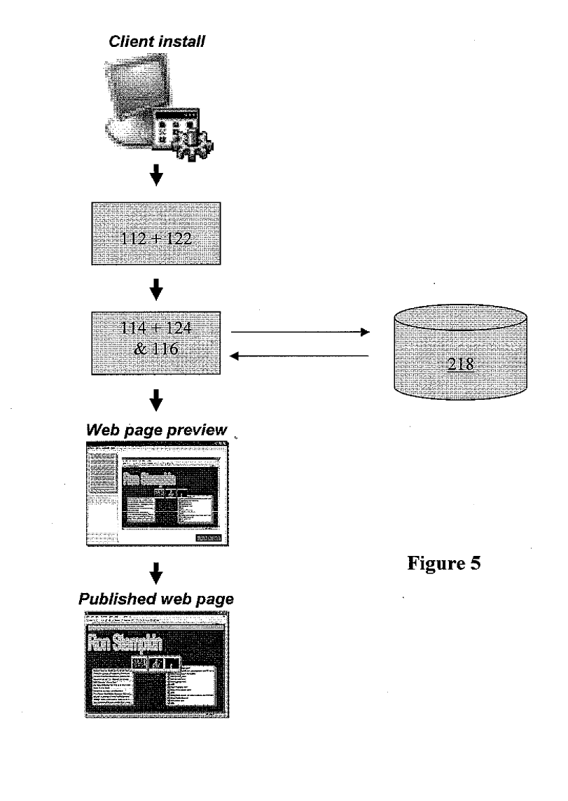

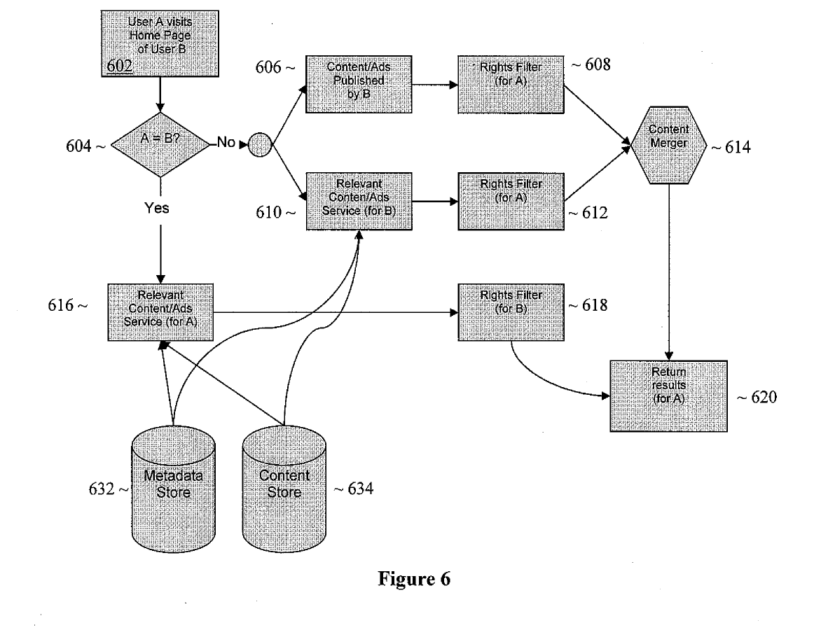

As alluded earlier, embodiments of the present invention may be practiced to automatically create a persona representation in a social network based on user activities, thus enabling the social network to propagate and present to each user of the system a set of constantly changing content that the user will likely find interesting (relevant). As illustrated by FIGS. 5-6, the content may originate within the system or from external sources available to the system. The content is published substantially automatically, based upon a broad set of discovery methods. These methods, in various embodiments, look at factors such as the person's social network, what music they are listening to, how they behave at one or more web sites, and so forth (user activities associated data). These discovery methods, implemented using e.g. the earlier described approaches, require relatively little action on behalf of the user; the user just needs to have friends that are also members of the social network. This social network could be embodied via a web site or via some other electronic mechanism. We will refer to the electronic mechanism by which the users interact as the “social network.” The members will ideally listen to music or take photographs or browse through the social network. All of these are considered natural actions for users of the system. From the simple act of having friends and occasionally (or better yet frequently) interacting with the social network, the system is able to provide a constantly changing set of content. This content, in various embodiments, is delivered directly to the user's desktop in addition to their home page on the social network. Although it is natural for the social network embodiment to be delivered via a web site, in alternate embodiments the content may be delivered to other devices of the user—such as the user's personal digital assistant, cell phone, portable media player and so forth.

The social networking system implemented this way combines this constantly changing content with another innovation: the system exposes what the system is delivering to a person's desktop to anyone who visits the person's home page. For example, suppose that the system is showing user A content items 1, 2 and 3 on A's desktop. These items appear on user A's desktop as well as on user A's home page on the social network. If visitor B goes to user A's home page, visitor B will also see content items 1, 2 and 3.

Suppose then that as user A interacts with incoming content, the system changes the content user A sees to content items 1, 5, and 10. When user B goes to user A's home page, user B will also see items 1, 5 and 10.

Thus, user A's persona page is constantly changing simply by the act of user A having had minimal interactions with content on the social network. What this means is a complete shift of the typical viewer-participant ratio. Everyone using the social network is a participant and is acting as a discovery engine that others can see.

In various embodiments, the content that is shown to user B is processed through a set of permissions filters before being displayed. For example, suppose that content item 1 is marked as only visible for user A. The system will show items 1, 5 and 10 to user A. When user B visits user A's page on the social network, however, the system will only display items 5 and 10.

Using the approach described earlier, the social networking system may be endowed with several services:
A content selection system for selecting material to display to the user based on social network activity, which in this document we call the Relevant Content Service (implemented using e.g. services 114 and 124 of FIG. 1)
A Content Selection Service for selecting material that is published by a specific user. (implemented using e.g. services 114 and 124 of FIG. 1)
A Rights Filtering Service (implemented using e.g. services 114 and 124 of FIG. 1)
A Content Metadata Store (implemented using e.g. services 114 and 124 of FIG. 1)
A Content Store (implemented using e.g. services 114 and 124 of FIG. 1)
A Data Collection Service (implemented using e.g. services 112 and 122 of FIG. 1)
A Content Merging Service (implemented using e.g. services 114 and 124 of FIG. 1)

In various embodiments, the Relevant Content Service may be designed to accept a user ID as an input, and provide access to a content metadata store that provides information about all content in the system and all user interactions with that content. From that information, the Relevant Content Service returns a set of content IDs that would potentially be of interest to the user, each of which has a relevance score associated with it.

In various embodiments, the content is selected at random from the entire set of content in the content metadata store, with each content having a relevancy score that ranges from 0 to 1, where the relevancy score may be e.g. the number of seconds from the current date back to the publication date of the content divided by the number of seconds from the current date back to the earliest publishing date of any content in the system.

In other embodiments, content may be provided based on people that the user knows. That is, for a given user ID, say 7, the system would look for other users in the social network that user 7 knows. This set of users could be determined in a number of ways, such as looking at what users user 7 has invited to the social network, or looking at what users user 7 has interacted with on the social network. Call this set of users set 1. The Relevant Content Service would then examine the content that has been uploaded by set 1. The relevancy score could be based upon date ranges, as previously discussed, or based upon how often user 7 has interacted with a given user in set 1, or some combination thereof.

In other embodiments, the Relevant Content Service divides the content uploaded by user 7 into two sections. One section would be content that was less than N days old (set A), where N is a value that can be altered within the system, and the other section would be content that is greater than N days old (set B). Given M items that the Relevant Content Service would like to return, it would attempt to select M/2 items at random from set A. If there are less than M/2 items in set A, then a smaller number of items will be selected from set A. We will designate the number of items selected from set A as P. The Relevant Content Service would then attempt to select (M-P) items from set B. The relevancy score could be based on date, as previously described.

In various embodiments, the Rights Filter Service is also designed to take as input a user ID and a set of content IDs, and return the subset of content IDs that the user with the particular ID is allowed to see. In various embodiments, a relational database is created for storing rights information. Each record in the relational database would store a user ID, a content ID, and whether the user was explicitly denied access to the content item. For example, if User A is not allowed to see Content B, then there could be a record that contains the ID for User A and the ID for Content B. Given a set of content IDs and a user ID, the Rights Filter Service can perform a query against the database returning all content IDs from the set that do not have a corresponding record with that ID and the user ID.

In various embodiments, the Content Merging Service is designed to merge together content from many different sources, such as the Relevant Content Service content and the user uploaded content. In various embodiments, percentage targets are established for each source. For example, suppose that the Content Merging Service needs to return M items, and has sources 1, 2, 3. Suppose it is given targets of returning x % from source 1, y % from source 2, and the remaining from source 3. With such a system, the Content Merging Service would sort content from each source based on relevancy, and then attempt to select the top M*x % items from source 1. Since source 1 could have fewer than this many items, call the number of items that were selected P. The service would then attempt to select (M+(M*x %−P))*y % items from source 2. Call the number of items selected Q. The service would then attempt to select M-P-Q items from source 3.

In various embodiments, the Content Metadata Store may be designed to store information about all content in the system. In various embodiments, a relational database is employed. The relational database may contain a table describing users, a table describing content, and a table describing interactions. The table describing users would provide a unique ID for each user and any other information the system needed to store, such as email address. The table describing content would store the type of the content, the ID of the user that published it (a foreign key to the user table), when it was published, a reference to where the content was actually stored (a foreign key to the content store) and other descriptive information about the content, such as the title or size. The table describing interactions would store the ID of the user performing the interaction (a foreign key to the user table), the ID of the content with which the user interacted (a foreign key to the content table), the time of the interaction, and the type of interaction (such as viewed, rated, etc.). These tables can then be queried to satisfy requests such as:
What content has User A uploaded?
Who uploaded Content B?
What content has User A viewed?
Who has viewed Content B?
When was Content B uploaded?

The Content Store may be designed to store the actual content. In various embodiments, a file system is used. Given a content ID, the file system can have a set of directories whose names correspond to each character in the content ID. The first N set of characters could be used for directories, and the remaining set ignored. This enables the system to control how many items are stored in any particular directory. For example, if the system creates directories 4 levels deep, than an item with content ID 0192323 would be given the file name 0192323 and be stored in directory 0/1/9/2. Thus, the full path to the piece of content would be 0/1/9/2/0192323. The content store would return the path to the content item given a particular ID.

Given these services, when a User A views a page for a User B, the invention determines what to show User A. First, it calls the Relevant Content Service to get content for User B. This is passed to the Rights Filter service so that only content User A is allowed to see is returned. If User A is not the same as User B, then the system selects a set of content that has been uploaded by User B. This is passed to the Rights Filter so that only content that User A is allowed to see is returned. These two sets of content are merged together by the Content Merging Service and returned.

Thus, as illustrated in FIG. 6, during operation, the process may begin at 602, with User A coming to the social network and viewing the home page of User B. The system determines whether User A and User B are the same user (604). If User A and User B are the same user, then this means that User A is visiting his own page.

If User A is visiting his own page then the system calls the Relevant Content Service to determine what to show the user (616). The Relevant Content Service, in response, examines content that has been uploaded by users of the social network, and by analyzing user activity, determines what content will be interesting for User A.

The Relevant Content Service retrieves its information from a metadata store (632) which stores information about what content has been uploaded by users of the social network and what content and what home pages within the social network site have been viewed by users of the social network. The metadata store can be implemented in various ways, such as with a relational database in which each content item, user and home page has a unique identifier, and in which a field code indicates an action. For example, if user A uploads content B, then a record can be entered in the database indicating that user A performed action upload on content B. Likewise, if user C views content B, a record can be entered indicating that user C performed action view on content B.

The Relevant Content Service also retrieves information from a Content Store (634). This stores the actual content that the metadata service refers to. The Content Store can be embodied in a variety of ways, such as a set of files in a file system or a set of binary data stored within a relational database.

Once the Relevant Content Service returns a set of content items to display (610), the system passes them to a Rights Filter service (618). The purpose of this service is to make sure that the content that is returned (620) is content that User A is allowed to see. The rights service can be created in any number of ways. For example, the Rights Filter could be embodied in a relational database, in which each record contains a user ID, a content ID, and a right. For example, if User A is not allowed to see Content B, then there could be a record that says User A is denied rights to view Content B. Given a content ID and a user ID, the Rights Filter service can check the database to determine whether or not the user is allowed to see the content.

After the Rights Filter service has removed items that User A is not allowed to see, the resulting set of content items is returned (620).

If User A and User B are different users, then the decision process (604) moves to a different process. In this case, we perform two operations. Similar to the step previously outlined, we call the Relevant Content Service to determine what to show User B (610). Note that User A is looking at the page for User B. By calling the Relevant Content Service for User B (instead of User A), we are displaying to User A the content that we would normally show to User B.

The system then removes items from the result set that User A is not allowed to see (612). This is similar to what was earlier described, only in this case we are determining what we would normally show User B, but then removing content that User A is not allowed to see.

In addition, the system shows User A items that User B has uploaded to the system (606). In this process, the system examines the Metadata Store (632) to find content that User B has created. In various embodiments, the system divides the content that User B has created into two categories: recent and not-recent content. The service for selecting a subset of User B's content selects a set of content from the recent category and a set from the not-recent category. The recency is determined by looking at the metadata associated with the content. The percentage of content that should be selected from the recent and not-recent set can be established in a variable so that the system or administrators of the system can alter the values.

In various embodiments, the techniques used for selecting content from the recent and not-recent set could include stochastic sampling or relevancy algorithms as are used by the Relevant Content Service.

After the selection of a set of content, the system passes control to the Rights Filter (608). As with (612), this process is invoked to ensure that User A is allowed to view the set of content that is returned.

Then, the Content Merging Service 614 merges together the content that was selected by 204 and 206. The merging process can be embodied in a variety of forms. For example, all content could be returned by returning the complete set of content returned by the selection processes 606 and 610. Or, the two sets could be stochastically sampled to return a smaller set. Or, the two sets could be merged and relevance sorted to return a smaller set. Or, the two sets could be relevance sorted individually and then sampled equally. There are many other embodiments as well.

After the content is merged, the merged content is returned.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method to be performed on a client device comprising:
monitoring by the client device user activities on the client device;
applying a plurality of data collection rules, by the client device, to observed user activities on the client device to selectively generate a plurality of user activity associated data including actively associated and passively associated data;
filtering or modifying by the client device the generated user activity associated data based at least in part on a plurality of data filtering rules or data modification rules respectively; and
selectively reporting by the client device the user activity associated data, filtered or unfiltered, modified or unmodified, to a content selection and propagation service configured to select and propagate content or metadata to a plurality of client devices.

2. The method of claim 1, wherein the selectively reporting further comprises selectively reporting by the client device the user activity associated data, filtered or unfiltered, modified or unmodified, to a trusted peer client device configured to perform at least the method set forth in claim 1.

3. The method of claim 1, wherein the data collection rules comprise local data collection rules, and the method further comprises the client device accepting locally provided input of the local data collection rules.

4. The method of claim 1, wherein the data collection rules comprise externally provided data collection rules, and the method further comprises the client device accepting the externally provided data collection rules from an external source remotely disposed from the client device.

5. The method of claim 1 further comprises the client device analyzing the generated user activity associated data, with or without filtering or modification, the selectively reporting including selectively reporting by the client device the results of the analyses.

6. The method of claim 1 wherein the applying of data collection rules further comprises applying by the client device a plurality of data collection rules to generate a plurality of trigger events to trigger creation of other data of interest based on observed data, the selectively reporting including selectively reporting by the client device the other data of interest.

7. The method of claim 6 further comprising filtering or modifying the other data of interest by the client device in accordance with a plurality of data filtering rules or a plurality of data modification rules respectively, the selectively reporting including selectively reporting by the client device the filtered or modified other data of interest.

8. The method of claim 1 further comprising
receiving from the content selection and propagation service, by the client device, messages comprising content or metadata; and
selectively merging by the client device the received messages with locally queued messages comprising content or metadata.

9. The method of claim 8 further comprising selectively presenting by the client device, the merged messages to a user of the client device.

10. The method of claim 8 further comprising generating and queuing local messages comprising content or metadata by the client device, based at least in part on a plurality patterns relevant to the client device or a user of the client device.

11. The method of claim 10 further comprising determining by the client device the relevant patterns, employing a plurality of locally managed pattern analysis algorithms.

12. The method of claim 11 further comprising locally managing by the client device the pattern analysis algorithms.

13. The method of claim 10 further comprising sending by the client device the generated and queued messages comprising content or metadata to the content selection and propagation service or a trusted peer client device.

14. The method of claim 8 wherein the receiving further comprises receiving from a trusted peer client device, by the client device, messages comprising content or metadata, and the selectively merging comprises selectively merging by the client device the received messages from the trusted peer client device with the locally queued messages comprising content or metadata.

15. A method comprising
determining by the client device a plurality patterns relevant to the client device or a user of the client device, based at least in part on a plurality of locally collected user activity associated data, filtered or unfiltered, or modified or unmodified;
generating by the client device, a plurality of local messages comprising content or metadata based at least in part on the determined relevant patterns;
queuing by the client device, the generated messages;
receiving from a content selection and propagation service, by the client device, messages comprising content or metadata; and
selectively merging by the client device, the received messages with the locally queued messages comprising content or metadata.

16. The method of claim 15 further comprising selectively presenting by the client device, the merged messages to a user of the client device.

17. The method of claim 15 further comprising determining by the client device the relevant patterns, employing a plurality of locally managed pattern analysis algorithms.

18. The method of claim 17 further comprising locally managing by the client device the pattern analysis algorithms.

19. The method of claim 15 further comprising sending by the client device, the generated and queued messages comprising content or metadata to the content selection and propagation service.

20. The method of claim 15 further comprising sending by the client device, the generated and queued messages comprising content or metadata to a trusted peer client device.

21. The method of claim 15 wherein the receiving further comprises receiving from a trusted peer client device, by the client device, messages comprising content or metadata, and the selectively merging comprises selectively merging by the client device, the received messages from the trusted peer client device with the locally generated and queued messages comprising content or metadata.

22. The method of claim 15 wherein the determining is further based on other data of interest created by the client device, filtered or unfiltered, or modified or unmodified, the other data of interest being created by the client device in response to a plurality of trigger events generated by the client device based on the locally collected user activity associated data.

23. An apparatus comprising
at least one processor; and
storage medium coupled to the processor, having stored therein a plurality of programming instructions to be operated by the processor, the programming instructions configured to practice the method as set forth in claim 1 when the programming instructions are operated by the processor.

24. An apparatus comprising
at least one processor; and
storage medium coupled to the processor, having stored therein a plurality of programming instructions to be operated by the processor, the programming instructions configured to practice the method as set forth in claim 8 when the programming instructions are operated by the processor.

25. An apparatus comprising
at least one processor; and
storage medium coupled to the processor, having stored therein a plurality of programming instructions to be operated by the processor, the programming instructions configured to practice the method as set forth in claim 15 when the programming instructions are operated by the processor.
